(19) United States
(12) Patent Application Publication
(10) Pub. No.: US 2025/0045942 A1
(43) Pub. Date: Feb. 6, 2025

(54) OPTICAL RECOGNITION SYSTEMS FOR THE SPECIFIC DETECTION OF A HOSPITAL BED

(71) Applicant: Foresite Healthcare, LLC, Maryland Heights, MO (US)

(72) Inventors: George Chronis, Chesterfield, MO (US); Erik Stone, Columbia, MO (US)

(21) Appl. No.: 18/786,206

(22) Filed: Jul. 26, 2024

Related U.S. Application Data
(60) Provisional application No. 63/530,209, filed on Aug. 1, 2023.

(51) Int. Cl. G06T 7/50; G06T 7/13; G06V 20/64

(52) U.S. Cl. CPC G06T 7/50; G06T 7/13; G06V 20/64; G06T 2207/10028; G06T 2207/20021

(57) ABSTRACT

Systems and methods which utilize depth camera imagery, without reliance on other sensors, to identify the patient's bed in a room setting, regardless of the placement of the camera or even whether the bed is in the room initially. The systems and methods utilize various properties of a hospital bed which are distinguishable from other objects common in a hospital or other room to identify the bed. Identification of the bed can then serve as a basis for identifying potentially dangerous bed exit behaviors.

### CROSS-REFERENCE TO RELATED APPLICATION(S)

This application claims the benefit of U.S. Provisional Patent Application No. 63/530,209, filed on Aug. 1, 2023, the entire disclosure of which is herein incorporated by reference.

### BACKGROUND

### 1. Field of the Invention

This disclosure is related to the field of machine imaging and specifically to systems and methods which utilize depth camera imagery, without reliance on other sensors, to identify the patient's bed in a room setting, regardless of the placement of the camera or even whether the bed is in the room initially.

### 2. Description of the Related Art

Watching a toddler learn to walk, one may find it difficult to believe that falling can be one of the most dangerous things that can happen to a human being. While children are known to fall down on what seems to be a near constant basis and generally jump right back up, as one ages the potential damage from a fall can go up dramatically.

Directly, falls result in more than 30,000 deaths annually in the United States (400,000 worldwide) in individuals over the age of 65, with “accidents,” including falls, representing the eighth leading cause of death, in large part due to the risk of traumatic brain injury which can occur during a fall. Indirectly, falls can result in decreased independence, increased pain, reduced mobility, and an overall reduction in the quality of life. These, along with the possible need for surgery and pain relief medication, have each been paired with an overall reduction in life expectancy.

Falls are a particular concern in medical settings and even more particularly in acute care facilities or hospitals. In acute care facilities, even normally able-bodied people can be susceptible to a dramatically increased risk of falls and the elderly (who often require more medical attention) can be particularly susceptible. Treatments and medications (most notably anesthetics and pain killers) used in such facilities can make patients dizzy, nauseous, or confused leading to them having a greatly heightened risk of falls. Further, injuries or symptoms which sent the person to the facility in the first place (for example muscle weakness, damaged bones, or pain) can make a patient more susceptible to falls as well.

The susceptibility of the patient population in acute care facilities to falls is also combined with institutional issues with such facilities which can increase fall risk and severity. Hospitals often have smooth surfaced, and very hard, floors for easy cleaning and disinfection, but this can also make them slippery and more likely to cause injury. Further, hospital equipment is often bulky, but needs to be placed in close proximity to patient areas to make it accessible quickly which can reduce open areas and require more complicated navigation. Finally, since a hospital is generally a foreign environment to the patient, they are also susceptible to simple lack of familiarity and can misestimate the size and shape of steps or pathways resulting in a fall.

Falls for hospitalized patients are believed to present 30-40% of safety incidents within any hospital and will generally occur at a rate of 4-14 for every 1000 patient days at a hospital. For even a relatively small facility, this can lead to multiple fall incidents every month, and can make them a near daily occurrence for a large institution. While institutions will typically utilize systems that allow them to try and reduce the number of falls that occur, the fact that falls will occur to at least some patients in a facility is unavoidable. By humans utilizing bipedal upright motion, some people will, in any given time window, suffer a fall.

The problem is exacerbated because falls are often seen as preventable and, therefore, falls causing injury can result in penalties to the hospital in the form of reduced governmental recognition for quality of care. They can also be a source of malpractice lawsuits. Beginning in October 2008, Medicare stopped reimbursing hospitals for specific instances of this kind of “error.” The Centers for Medicare & Medicaid Services drew up a list of ‘reasonably preventable’ mistakes, termed ‘never-events’. After that date, injuries from falls in hospitals were no longer reimbursed by Medicare. On Jun. 1, 2011, Medicaid followed Medicare's lead in no longer reimbursing hospitals for ‘never-events’, including falls. Additionally, the Affordable Care Act imposes payment penalties on the twenty-five percent (25%) of hospitals whose rates of hospital-acquired injuries due to falls are the highest.

In response to these business risks, acute care facilities will often take considerable care with regards to falls, but every consideration must also take into account cost and resource management. The issue then comes down to determining how to assess the fall risk of any particular individual at any particular time so as to mitigate the number of falls, and the damage done by those that will inevitably happen, across the institution as a whole.

It should be recognized that there are generally two different types of mitigation related to a person falling. Generally, the most common concern is reducing the likelihood that a person will fall at some time during their stay in an institution. In effect, if no one was to fall, no one can be injured from a fall, so the risk of a fall related injury is zero. However, any person that can stand is at a non-zero fall risk as even completely able-bodied individuals can trip and fall unexpectedly. At the same time, those with certain conditions are clearly at a heightened risk and detecting them can be useful for focusing resources to the highest risk patients. For example, a person whose legs are weak and who ambulates unsteadily will typically be much more likely to fall during an acute care facility stay than one whose motion is more steady.

While much fall risk is generalized over the entire window of a stay, there is also a more defined type of immediate fall risk. This is typically due to the person's situation at a specific time compared to at other times during their stay in the facility resulting in a dramatically heightened (or lessened) fall risk. As a simple example, the disorienting effects of anesthesia will typically make one coming off of it have a much greater fall risk than they would have been before receiving it at all. In the other direction, a patient who is sound asleep typically has a very low immediate fall risk. These changes to immediate risk are also typically true regardless of the relative risk of a patient compared to others at the time of their arrival.

The second issue of fall risk is concerned with detection that an individual is in a situation where a fall either is about to occur, is occurring, or recently has occurred. In these cases, the fall typically cannot be prevented. However, quick detection of the fall event allows for aid to be provided to the individual quickly and for the damage done by the fall to be reduced. In effect, these systems are often not as concerned with reducing the likelihood of a fall occurring, they are concerned with minimizing its potential impact or injury on the patient. This type of fall detection, thus, attempts to reduce the burden on the facility by hopefully reducing the number of falls resulting in a reportable injury, or reducing the level of care necessary to treat a resulting injury, which may need to be absorbed by the facility.

The two types of fall detection often work together with a facility providing resources to inhibit any falls to the most vulnerable patients and then diligently working to detect when inevitable falls occur to minimize their impact. Because every patient's fall risk is non-zero, the only way to prevent falls is to prevent patient ambulation and this is often a facility's first fall risk response. While systems to prevent (or at least severely inhibit) ambulation can be effective, they are also typically very intrusive on patient autonomy because they prevent a patient from falling because the patient is not given the opportunity to ambulate normally. Such systems and procedures include the use of relatively straight-forward systems which stop or inhibit a patient from being able to put themselves in a position to fall to simply providing warnings to try and scare a patient about the risk of falls and have them voluntarily choose to not ambulate. Bed rails on hospital beds and required movement by wheelchair are examples of physical restraints that inhibit a patient from ambulating to inhibit falls.

Because these systems typically provide direct inhibitions on a patient's autonomy when they are within the facility, they often invoke negative responses from patients. Further, they are usually resource intensive as they require nurses or other facility personnel to actively assist the patient whenever the patient wishes to move. For this reason they are often only used at certain times when fall risk is extreme. In some cases, this is an easy determination. Bed rails, for example, are often raised when patients would be waking up from anesthesia and would be at an extreme fall risk. Their presence both inhibits the patient from ambulating (by simply making it more difficult and time-consuming to do) and can act as a psychological deterrent by their presence indicating to a patient on a bed that they should not exit but should call for assistance. Further, as the typical time to awaken from anesthesia is usually a relatively short window, the need for a high level of monitoring to respond to the patient waking up is relatively time constrained.

However, while waking from anesthesia may be an easily determinable high risk situation, many more are not. To effectively allocate limited resources, staff must attempt to assess those patients with the greatest need for active assistance, which should correlate with fall risk, and provide preventative systems to those patients to most effectively reduce the incidence of falls at the facility overall. This initial determination step, while effective at some level of cost control, is not perfect. Most fall risk assessments are highly subjective, based upon either the individual's own perceptions of their risk, or the perceptions of health care employees, which may be based upon a limited history or information. Further, fall risk often is both relative to other patients, and to the patient themselves at different times. For example, an older patient who is unsteady and walks with a cane may be at a substantially increased fall risk compared to a patient who is steady on their feet when they both first arrive, but if the later patient has a procedure performed which results in temporary numbness in a foot, while the former has a simple non-intrusive exam, the situation may be reversed when they leave. Further, as resources are limited, they often can only be provided to a certain number of cases with the highest risk. Thus, attempts to decrease total falls within any facility becomes a highly complex equation where limited resources need to be allocated to determine relative risk and limited resources need to be allocated based on the shifting relative risks both between different patients in a population at any one time and shifts in patient populations over time.

One constant is that typically the more resources available to stop falls, the more falls are reduced. However, that overall reduction typically comes with increased cost and decreased patient autonomy meaning optimal fall reduction levels are nearly impossible to determine. In general, the inaccuracies in risk determination, both overall and over time, coupled with a healthcare facility's very reasonable desire to decrease liability and the costs of failure, causes facilities to generally overestimate falling risk. This results in wasted resources from patients having to rely on the provision of assistance when they do not need it. Further, should assistance not be prompt, patients may not wait for assistance and actually cause a fall that should have been prevented with their impatience.

Further, if fall prevention is too strongly implemented, the need for more patients to receive assistance from staff every time they wish to leave bed to make sure that they do not fall combined with staff being bogged down taking regular reassessments of patients to determine changing fall risks can result in a difficulty in allocating limited fall risk resources and end up costing more than the damage that would be caused if the falls were simply allowed to occur without intervention. The cost and effort of accurate risk determination can also result in such determinations only being done at a very course level and overly quickly. In effect, the risk determination process itself bogs down the care process in such a way that it becomes more of a hinderance than a benefit. As more accurate reassessments are time consuming and need to be ordered with a regularity to be actionable (often every four to eight hours) that prevents any real change from being documentable and makes the risk assessment process overly costly for its effectiveness. Such reassessments often become a low priority for overly tasked medical staff, and are often not performed or not performed well, making them ineffective and the procedures to reduce fall risk failing to mitigate, or even actually increase, fall occurrence. Thus, many facilities simply fall back on general knowledge and principles to make course determinations and selections for who is at the greatest fall risk to carry out some overly restrictive level of reduction while accepting that anything more accurate is simply too difficult to carry out accurately. In this way, facilities can always fall back on simply asserting that they provided accepted industry level attempts to reduce falls.

Since reductions from more accurate determination of patients at high fall risk are often difficult to obtain, reductions in cost to this process are now often obtained by providing more automated systems to respond to or inhibit falls through instantaneous assessments. Specifically, instead of having a patient at heightened fall risk confined to a bed, at least until they get assistance, the patient is provided with a passive monitoring system which may, at any instant, inhibit falls by encouraging waiting for assistance (if the fall risk is deemed sufficiently heightened at that instant) or allow the patient to be autonomous in their movement (if it is not). The systems can then continue to monitor so that a fall which actually does occur is quickly detected. These types of systems provide for finer control of a patient population by allocating active assistance based on instantaneous fall risk of a patient, versus their overall fall risk and by focusing on mitigating injury from falls which do occur. Due to their speed of assessment, they can often remove many of the layers of complexity from the fall risk analysis and dramatically decrease costs.

These types of systems typically either passively monitor the occurrence of falls, or detect when the likelihood of a fall increases. In this way more inhibitive measures may be limited to more vulnerable patients at that instant and more patient freedom may be maintained. Further, resources can be more widely distributed. Many hospitals attempt to detect falls, or predict falls before they occur, through the use of sensors associated with a patient. In the most straightforward form, these systems utilize computer models to analyze a patient's movement to determine how stable they are analytically, and then request assistance for those at increased risk. More complex systems attempt to monitor and look for falls at times when they are more likely. In effect, a fall risk assessment is generally determining who is more likely to need assistance and a bed alarm is simply trying to indicate when.

In the vast majority of cases, fall risk increases at the point of bed exit. Bed exit is an activity with an increased risk of fall for virtually every person in an acute care setting. In the first instance, patients in such facilities spend most of their time in bed as the bed is used as their primary piece of furniture. Even fairly able bodied patients will typically sit, read, watch TV, eat, and sleep in their hospital bed. Thus, if a patient intends to ambulate, they often do so from the bed. Should they be moving from elsewhere, that is often only because they have previously gotten up from their bed and often because they have done so only a short time previous. Thus, if they were deemed to be a relatively low risk at the time they originally exited their bed, this often will not have changed at the time they return to it.

The other reason that bed exit is often a major issue associated with falls is because going from a prone position to a sitting position and then to a standing position requires substantial muscle coordination and balance. Further, the prone position essentially requires no balance or strength (which is why it is so common in an acute care setting) making the transition from prone to standing a high risk activity when it comes to falls. Such movement also typically comes shortly after waking (when a patient is often most disoriented).

Because of the fall risk that is associated with bed exit, bed exit is typically a very important trigger for automated systems to both detect and to act on. Bed exit systems typically work on one of two principles. Simpler systems simply seek to look for a patient no longer being in bed and to potentially have fallen or to now be ambulating. To put it simply, the systems try to detect a patient is not in bed and, therefore, either ambulating (at a risk of falling) or prone on the floor (having fallen) and react to that change in circumstances. More complex systems attempt to detect that a patient is either getting up, or is moving relative to a bed indicating that they may get up, to give more advance warning of a potential fall or quicker response to an actual fall by detecting a likely exit before it actually occurs. Embodiments of such systems are contemplated in, for example, U.S. patent application Ser. No. 16/942,479 and U.S. Pat. No. 10,453,202, the entire disclosures of which are herein incorporated by reference.

These systems often also take into account the patient's general fall risk as well. Where a patient has been deemed at a heightened fall risk, the patient can be placed in a bed, either with a bed exit alarm affixed to it, or in a bed that has a bed exit alarm which was incorporated into the bed at the time of manufacture. When a patient exits or begins to exit a bed where an alarm is installed, an alarm goes off allowing for the increased potential of a fall because the exit is being carried out by this particular patient to be rapidly identified and responded to.

The most obvious problem with most existing bed exit alarms, which often rely on changes in pressure on the mattress, is that they can merely detect that a patient has left their bed and, therefore, can detect that there is an increased risk of fall because they are now standing and/or ambulating or have already fallen. While a patient that has left their bed is clearly at an increased risk for a fall, they are at risk for such fall the instant they leave their bed. Thus, many existing bed exit alarms effectively act to notify personnel that an individual is at a dramatically heightened fall risk only after they are at such risk or have already fallen. Many such systems can also not distinguish between a patient who is successfully ambulating after rising (but may be at an increased risk of falling) and a patient that has already fallen. As an individual with a high risk of fall is very likely to fall quickly after leaving their bed or chair or even as they are leaving it (before they have even had a chance to ambulate), by the point a prior alarm goes off, the fall (and resulting damage) is likely done.

Thus, these systems act more to quickly detect that a fall has occurred and minimize its impact, than to inhibit the likelihood of one occurring in the first place. As such, they often over react and produce substantial false positives. Specifically, they will sometimes treat a high risk bed exit the same as a fall. When the two do not correlate, trust in the system's accuracy can be lost. While such action can valuable to reduce risk of long term damage from the fall due to quick response, the fundamental problem of not inhibiting the fall in the first place is left unsolved by many prior systems and this goes a long way to explain why many conventional systems only decrease falls by about twenty percent (20%) according to current statistics.

Bed exit alarm systems built into the bed also have other flaws. First, they suffer from a significant rate of false negatives-alarms failing to go off when a patient has exited-which obviously defeats the purpose. They also suffer from substantial false positives-alarms going off when a patient has not left bed but is instead just moving or rolling over, or even just sitting up for a bit. These must be treated as true positives and investigated, taxing healthcare employee resources.

Still further, hospital beds are already complex systems and needing to add additional sensors to them to help detect bed exits can continue to increase medical costs both directly and through increased ongoing maintenance. Bed sensors typically need to be positioned on top of the mattress (under bed linens), or under the mattress, to detect the patient accurately. As bed linens, and even the mattress itself, in a hospital setting often need to be regularly cleaned and disinfected, the inclusion of a bed sensor as a part of the mattress or linens can make these processes substantially more difficult. Thus, most bed sensors are actually inserts that go on the bed in addition to the mattress and linens. This can lead to bed sensors being misplaced or not reinstalled in the correct manner or location when the bed is turned over from one patient to another or can make the mattress uncomfortable to the patient. In such a situation, the sensor may operate sub-optimally, or not at all, when it is still being relied on for fall safety.

To avoid the need to provide sensors in the bed, systems such as those described in U.S. patent application Ser. No. 13/871,816 utilize external sensors to detect bed exit and patient ambulation. For example, a depth camera or other device which can obtain depth image data to analyze an individual's gait can be used. Image analysis, such as is described in that application, effectively requires 3-Dimensional (“3D”) image data, which is why a depth camera is used. Image analysis can be very valuable in fall risk assessment as certain elements of gait, and changes in gait, can indicate increased likelihood of falling. Further, certain actions in a gait (such as the motion of stumbling) can be immediate indicators of a dramatically increased immediate fall risk or, upon analysis of the 3D image data, that a fall has occurred or is occurring. Machines can generally automatically detect that such a fall has occurred based on the movement of the patient and immediately notify caregivers to come to their aid.

Depth cameras can also be useful tools to detect bed exits such as are discussed in U.S. patent application Ser. No. 18/230,603 the entire disclosure of which is herein incorporated by reference. To detect bed exit, however, a depth camera needs to be able to detect not just the patient, but also the bed.

While the detection of human figures has been a prior focus of depth camera image interpretation, the need to detect a bed with the same imaging system has often been overlooked. The reason for this is simple. A bed in many systems is effectively background to a depth image camera that is designed to watch a human. However, when one wishes to focus on, a human's movement from a bed, as is often desirable in advanced fall detection systems, it becomes necessary to detect and accurately define the bed to allow for such human interaction with it, as opposed to with other pieces of furniture, to be detected. In this way factors such as the position of the bed, the position of bed rails, and the interaction of the human with the bed and bed surface can be better evaluated in determining their instantaneous fall risk from getting up.

While external monitors aren't attached to a patient, external monitors for a patient still need to be present with the patient. If an external monitor is not going to be provided for every patient (e.g. with every room), it means that to provide fall risk calculations using such a monitor, the monitor typically must be brought to the patient's room. When a monitor is built into a room, it can be setup so the system knows the basic design of the room and the shape and location of specific pieces of furniture including the bed. While this will typically provide increased system simplicity and accuracy, it means that each system is confined to its room. That can decrease the availability of the system to patients when they most need it.

For this reason, there has been a desire to allow depth camera monitoring systems to be brought to the patient or to be installed in rooms where the bed itself moves with the patient. In this way the system is provided when it is needed, and can easily be taken away as circumstances change. This allows limited units to be more effectively allocated to a greater number of patients at times when heightened monitoring is expected to be most valuable. While this arrangement provides for more efficient resource allocation of fall detection systems, it does require that the system be able to adapt to new rooms, new beds, and new environments quickly. A major concern is that human error in the setup of such a monitor in a new room can lead to the depth camera not accurately imaging the points of most risk. This is often the bed surface and a patient on it. Moved monitors can be setup with cameras blocked, aimed the wrong direction, or simply without the full bed or other target in their field of view which can quickly reduce their effectiveness.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, provided herein are systems and methods for allowing a fall detection system, and particularly one that relies solely on a depth camera, to, in real time, make sure that it has been correctly oriented when it is placed in a new environment using the depth camera perception for such detection. Particularly, when the system is used in an acute care setting for fall detection, the system can detect that its field of view includes a bed and that it identifies an object in its field of view as a bed and specifically the top surface of the bed (or the surface upon which a patient will be positioned). This allows the system to orient itself correctly. It is also valuable to make sure that the bed surface is positioned sufficiently in the field of view to allow for automatic monitoring to be considered effective. In this way, the system is able to automatically authenticate its setup and then detect interactions of human figures with the bed surface to best detect an attempted bed exit by a patient which is often the most likely and concerning source of potential falls.

### BRIEF DESCRIPTION OF THE DRAWINGS

FIG. 1 Provides a general block diagram of an embodiment of a fall detection system for an acute care facility that can utilize the systems and methods of optical detection of a hospital bed.

FIG. 2 Provides a flowchart illustrating an embodiment of a method for optical detection of a hospital bed.

FIG. 3 Provides a flowchart illustrating another embodiment of a method for optical detection of a hospital bed.

FIG. 4 Provides a simplified edge pattern to illustrate certain concepts of the optical detection of FIG. 3.

FIG. 5 Provides a hypothetical bed surface polygon detected in the edge pattern of FIG. 4.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matters contained in the description or shown in the accompanying drawings shall be interpreted as illustrative and not in a limiting sense.

Described herein are systems and methods which allow for machines to detect and identify a hospital bed, and specifically, the upper surface of a hospital bed, in its field of view, using purely spatial recognition systems typically in the form of depth camera imagery. To put this another way, the systems and methods utilize depth cameras and other sources of “machine vision” as the primary or sole input to determine that a hospital bed is correctly within the system's field of view and that, thus, the system has been correctly placed in the room to perform effective fall risk analysis which involves the bed as an object. These systems thus solve technological problems presented by the use of mobile depth camera systems for fall detection based on bed exit. In particular, the systems and methods discussed herein allow for the system to make sure they are correctly positioned in a room and to create in machine memory an indication of an object which is identified as a hospital bed which is typically necessary for further vision analysis for fall detection to have a record of.

The systems and methods do this by recognizing certain features of hospital beds that are typically different than other potential objects and determining if an object with these criteria is correctly positioned in the field of view. If one is, the system then locates and defines the upper surface of the bed. Once defined, the system will typically utilize this area as the bed for purposes of detecting interaction with the surface by humanoid figures and ultimately to evaluate fall risk. If a bed surface is not detected for any reason, or is detected at a position that is undesirable for use in the fall risk detection, the system can issue an error to encourage it being repositioned.

This application will primarily discuss locating a “hospital bed.” This term is used herein to distinguish the bed typically used by a patient, from other pieces of furniture which may be in a room. Further, the present application relates to detection of a hospital bed within some form of acute care facility. This may be a conventional hospital and the terms “acute care facility” and “hospital” will often be used interchangeably herein. However, the facility can be other forms of care facilities such as an outpatient surgical center or a testing center where patients commonly are provided with beds and these are also intended to fall within the terms “hospital” or “acute care facility” as well.

As part of this disclosure, a hospital bed will typically be distinguished from a “conventional bed” or other piece of furniture. A “conventional bed” in the context of this disclosure is a bed which may be in the patient's room, but is not really intended for use by the patient. It will often be for the use of another. For example, labor and delivery rooms, will often include a conventional bed (often in the form of a futon) and other furniture (such as a large couch, sleeper sofa, or even cushion arrangement) which provides for a place for a spouse or similar guest who is present in the room with a pregnant woman in labor (who would be using the hospital bed) to sleep on. A conventional bed could also be in the form of a crib or similar device, or a more standard bed, that may be present in a post-partum hospital room.

It should finally be recognized that hospital beds can be used at facilities which are not acute care facilities. For example, hospital-style beds may be used at home. The term “hospital bed” in common parlance is often used to refer to a medical style bed of the type used in hospitals but which is used in the home or other facility for those who have in home medical care or other specialized needs or simply because someone wants to have one. However, in the present case, the term “hospital bed” is more commonly referring to a bed in an acute care facility which uses that term because of its location and its use by and for a patient in such a facility not simply because of its general design. Further, beds used in an acute care facility are typically designed for such use and, therefore, often have to meet more strict criteria compared to those used in home settings. For example, hospital beds in an acute care facility are typically designed to only accommodate one person (the patient) while hospital beds designed for home use may be larger to accommodate multiple. Further, hospital beds in an acute care facility will typically have controls and structures designed to be used by nurses and other caregivers that are not the patient and may include structures specifically for use in a medical emergency. As a simple example, a bed in a hospital may include a CPR latch which will quickly collapse the bed to flat to allow for a patient in cardiac arrest to be treated quickly and so that caregivers do not need to wait for hydraulic systems (which are often designed to provide for a more comfortable moving experience) to adjust the components.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

As will be appreciated by one skilled in the art, some aspects of the present disclosure may be embodied as a system, method or process, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Program code embodied on a computer readable medium may be transmitted using any appropriate medium, including but not limited to wireless, wireline, optical fiber cable, RF, etc., or any suitable combination of the foregoing.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the term “real time” refers to software operating within operational deadlines for a given event to commence or complete, or for a given module, software, or system to respond, and generally invokes that the response or performance time is, in ordinary user perception and considered the technological context, effectively generally cotemporaneous with a reference event. Those of ordinary skill in the art understand that “real time” does not literally mean the system processes input and/or responds instantaneously, but rather that the system processes and/or responds rapidly enough that the processing or response time is within the general human perception of the passage of real time in the operational context of the program. Those of ordinary skill in the art understand that, where the operational context is a graphical user interface, “real time” normally implies a response time of no more than one second of actual time, with milliseconds or microseconds being preferable. However, those of ordinary skill in the art also understand that, under other operational contexts, a system operating in “real time” may exhibit delays longer than one second, particularly where network operations are involved.

This disclosure is focused on systems and methods which provide for a depth camera system to detect that it has a hospital bed in its field of view and, if it does, to define the scope of the bed surface which is intended to be the surface of the bed which actually is in contact with (or at least close to) the patient. Defining the bed in the system's vision is typically a necessary precursor to the system being able to review interactions with the bed and is, thus, necessary before a bed exit determination can be made by the same system.

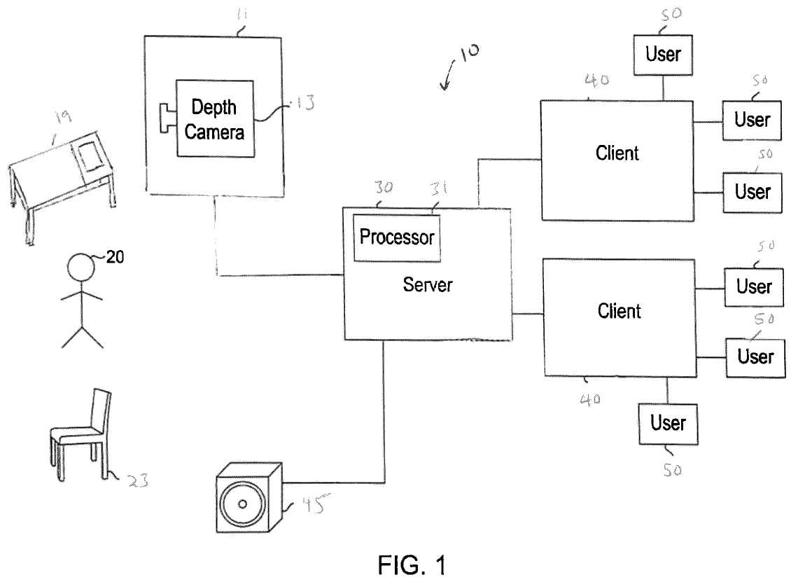

The detection systems and methods discussed herein are generally performed by a computer system (10) such as that shown in the embodiment of FIG. 1. The system (10) comprises a computer network which includes a central server system (30) serving information to a number of clients (40) which can be accessed by users (50). The users (50) are generally humans who are capable of reacting to a potential fall as part of their job or task description. Thus, the users (50) will commonly be medical personal, corporate officers, or risk management personnel associated with the environment being monitored, or even the patient (20) themselves or family members or guardians. The users (50) could also be fully automated systems in their own right. Information or requests for feedback may also or alternatively be provided to a patient (20) directly. For example, if a patient (20) is detected as getting up, the system may activate a communication system (45) in the patient's (20) room asking them to wait for assistance.

In the embodiment of FIG. 1, the primary, and often only, source of input about what is occurring in the room is a depth camera (11). The depth camera (11) will typically monitor the patient directly but be disconnected from the patient (20) and from the bed (19). In an embodiment, the depth camera (11) may be a fixture in the room (for example being mounted to the ceiling or out of the way) so that it can monitor activity within the room. However, in the primary embodiments of this disclosure, the depth camera (11) is part of a temporary device, such as a cart, which is brought into a specific room to handle fall detection for a specific patient at certain times. While a depth camera (11) will typically be used to monitor a patient, or at least a humanoid shape, in this disclosure the focus is on the depth camera (11) detecting and defining the bed so that the aiming of the system when setup can be verified and the patient's interaction with the bed can then be determined.

In the primary embodiments, the depth camera (11) is the sole detector in the room and cannot rely on another sensor such as a bed sensor to determine the activity of a patient (20). Thus, the camera (11) as contemplated herein utilizes the interaction between specific forms of image processing to detect a bed surface.

It should be recognized that this disclosure will discuss image analysis by a machine processor (31) using wording such as “recognizes” and other human concepts. It should be understood by the reader that the machines herein do not need to process images in a manner similar to or even comparable to the manner they would be processed by a human observer visually watching the image or in the fashion of the attached FIGS. which are designed to illustrate concepts to the human reader. However, language which refers to such processing will typically utilize the processing by the human observer as a proxy representing the easiest way for a human reader to understand the processing that is occurring. For this reason, this disclosure should in no way be used to imply that the machines used herein are “sentient” even if they are ascribed human characteristics in the discussion of their decision making.

In an embodiment, the depth camera (11) will generally comprise an imager (13) or similar optics which takes video or similar image-over-time data to capture depth image data. Specifically, this provides for 3D “point clouds” which are representative of objects in the viewing range and angle of the camera (11). Operation of depth cameras (11) is generally well known to those of ordinary skill in the art and is also discussed in U.S. Pat. No. 9,408,561, the entire disclosure of which is herein incorporated by reference, amongst other places. In order to provide for increased privacy, the depth camera (11) may utilize silhouette processing as discussed in U.S. Pat. No. 8,890,937, the entire disclosure of which is herein incorporated by reference. To deal with monitoring at night or under certain other low conditions, the depth camera (11) may utilize recording optics in an electromagnetic spectrum outside of human vision. That is, the camera (11), in an embodiment, may record in the infra-red or ultra-violet portions of the spectrum.

While the depth capturing camera (11) can operate in a variety of ways, in an embodiment the camera (11) will capture an image and the processor (31) will obtain the image, in real-time or near real-time from the camera (11) and begin to process the image. This process will typically commence when the depth camera (11) is placed in the room and turned on. In this way, the camera (11) may determine if a bed is in its field of view, and if one is, its bed surface. The camera may then use this determination of the location and definition of the bed in fall risk processing based on patient interactions with the bed.

The depth camera (11) observing a hospital room or other acute care facility room will typically be able to resolve the image into points which form point clouds. These points are at a location in the x/y coordinates of the image, and are also at a depth (z coordinate) into the image. This structure can be used to find “edges” which allows for the detection of “clouds” or other separable “objects”. In effect, an object is commonly detected in machine vision due to its having an edge. That is, if one thinks about the depth that the point (representing the surface of something closest to an observer is from them) an object will have a sudden drop off at the edge of the object. As a simple example, The negative shape of a box can be seen by picking a fixed point and placing lines from a point of observation toward it as the edges of the box result in shorter lines than those that miss the box.

This quality of edge detection allows for the depth camera (11) to detect “clouds” or collections of points in the image. These clouds are effectively shapes where a majority of the points are much closer to the camera (11) than others which are off the cloud (over the edge). If one thinks of the longest distances as being the structure of the room (e.g. walls, ceiling, and floor), objects in the room will show up as clouds in the foreground. These clouds can then be interpreted into objects of different types. For the purposes of this disclosure, the interpretation of clouds into objects is primarily focused on the use of their edges. That is places where there is a sudden change in the length of the z-coordinate of adjacent image points. It should be recognized that the problem with “cloud” objects is that those nearby or in contact can merge into each other and a nearer cloud will obscure, and potentially combine with a cloud behind it. Thus, a detected edge could actually comprise an edge of a real object, or could simply be a bend or similar part of the same object. For example, if examined from the front, there is typically an edge between the front of the seat and the backrest even though both the seat and backrest are part of the same real-world object.

While the detection and use of “edges” in the image will be discussed in conjunction with an embodiment of the present systems and methods it should be recognized that edge detection is not necessary. In alternative embodiments, the vision system may detect other shapes and objects. In particular, the system may not detect edges, but may look for continuous surfaces or shapes. Commonly, even in edge detection systems, the system (10) will need to define a background of objects through which the clouds of interest move. Often, a part of this background is the bed. However, the bed has unique value in determining in a depth sensing system fall risk because the patient exiting the bed is often an activity which is to be detected and evaluated.

The system (10) may detect a hospital bed (19), through the recognition that a hospital bed (19) will typically be visible as a point cloud having certain characteristics not present in other furniture or objects in the room and that such parameters will typically be best evaluated by its edges. As such, the system (10) will typically provide a set of parameters for review the image produced by the depth camera (11) and compare the detected cloud edges or shapes against. These parameters will define an object which is to be treated as the patient's bed (19), and often more specifically the upper surface of the bed (19), by placing bounds around what such a surface could be. The parameters will typically comport to dimensions, or ratios of dimensions, that can correspond to edges or shapes that will likely be detectable when the bed (19) is imaged by a depth camera (11). The parameters will also often take into account ways that the bed (19) may be arranged within the room.

Parameters are valuable as a tool to detect a hospital bed (19) because, while there are hundreds of different brands and styles of hospital beds (19) that a facility can use, most hospital beds (19) fall within specific ranges for their designs and dimensions. Further, because hospital beds (19) are used for many purposes beyond just sleeping, hospital beds (19) often have a variety of different functions and arrangements that are not available to more conventional beds which allows them to be configured in more configurations and adjustable positions but those positions are also relatively confined because of their medical use or comfort value and because of the underlying shape of the bed (19). Thus, while any one hospital bed (19) can vary in design from another, the variance between a hospital bed (19) and another object (for example a chair (23)) will typically be greater than the variance within hospital beds (19). Determining specifics of these differences can allow for bed detection if certain parameters of a detected “cloud” object fall within certain ranges.

The present systems and methods, thus, perform detection of a bed (19) by recognizing that hospital beds (19) in a facility will have parameters with within these relatively limited ranges and that other furniture (23), or objects typically within a hospital room, often are not inside those ranges. Further, if more specifics are known about beds in a specific facility, this additional information can be used to further limit the ranges of the parameters making the detection both easier and often more accurate.

Hospital beds (19) share a number of similarities that are not true for conventional beds. For example, hospital beds are typically designed to hold only a single person. To put this another way, most are typically always around the size of a twin size conventional bed. Therefore, their upper surface will typically be more strongly rectangular than is the case with some conventional beds where a king size bed, for example, is effectively square. However, while this ratio is useful for eliminating a variety of pieces of furniture from consideration (for example, it can eliminate larger beds or bed-like objects, lamps, and non-rectangular objects) it does not eliminate all of them. For example, a non-hospital twin bed, futon, or even mattress could readily be present in a room (for example in a labor and delivery room where such object may be provided for a spouse or visitor) and objects such as couches or even a chair viewed at the correct angle could have similar shape to a bed surface viewed from the same, or a different position.

However, hospital beds (19) are also almost always quite high compared to their conventional counterparts. This is typically to accommodate wheels and other transport mechanisms, as well as adjustment mechanisms which exist in the bed frame. The beds (19) are also quite high to allow for other items to be built or stored in their frame. This can include, for example, batteries and other power sources, hydraulic systems, and oxygen systems. Thus, the ability to detect the height of the bed surface from the floor, or the presence of objects unlikely to be present under non-hospital beds can be valuable. As a simple example, detection of wheels is possible. Alternatively, the detection of axles or lift frame components in an area under the bed surface can be helpful in some embodiments.

Finally, hospital beds (19) typically also include rails. The rails are usually adjustable between a raised and lowered position, but importantly, they are almost always present on the sides of the bed. Rails can often interfere with vising detection of the bed surface and it may be important to detect them to allow for the bed surface to be defined and also for the system to know if they are up or down. Raised bed rails will typically be a good indicator that the bed is occupied, but also that the patient is relatively safe from a quick fall as exiting the bed is much more difficult with the rails up. Further, rails can also be useful to detect themselves as both helping to define the location of the bed surface, and as a secondary parameter to separate a hospital bed (19) from a more conventional one.

A major complicating factor in detecting a hospital bed (19) is that a hospital bed (19) is typically adjustable and is often more adjustable than a traditional bed or used in more potions than a conventional bed. Specifically, because patients are often in bed for a long time and need to use the bed in positions where they are not prone, the beds can typically be arranged to provide for sitting positions, even those that are quite upright, as well as unique positions such as having the feet raised over the head. This is problematic because if the bed is viewed in one of these positions, it may actually be more akin to a chair shape and it may be important that the system be able to distinguish a chair from the bed. Further, a bed (19) is rarely the only thing in the viewing frame and it is possible that other furniture (or medical apparatus) that is also in view could block fundamental elements from being viewed that would help to distinguish the specific characteristics of a bed. For this reason, the system and methods herein will typically use multiple parameters in bed detection. Specifically, they will rarely rely simply on dimensions, ratios, or relative positions but will look at all of those things and potentially others. Further, the systems and methods will typically look for those values across essentially all things visible in the frame.

Detection of the bed will typically involve looking for the particular shape of the upper surface of the bed based on the edges and angles (corners) detected. It should be recognized that as a single generally twin-sized bed, this shape will typically be rectangular and will typically have only a relatively small range of relative and absolute dimensions. For example, the width of a hospital bed in North America is typically between 35 and 42 inches and is usually between 36 and 39 inches. Similarly, the length is typically between 74 and 88 inches with most being in the range of 78-80 inches. Further, the mattress on a hospital bed is typically thinner than a conventional bed is often only around 6 to 7 inches thick. It should be recognized that this provides for a general range, but it does not include all beds in use in an acute care facility. However, many larger beds or beds with different dimensions are often for specific purposes and the fact that the patient needs such a bed can often be recognized as part of the recognition program. For example, bariatric beds, which are designed for larger patients, are usually also designed to be within fairly specific ranges of length and width as well.

The size of the bed is often treated as providing a few different reference points. The first is that the bed mattress should be around the absolute dimensions expected for width, length, and thickness. The second is that the ratio of the height to width, height to depth and width to depth should also be around expected ratios. A third is that the bed mattress will have a mattress of parallelepiped shape with generally right angles at its corners and, when laid flat, the mattress is typically the topmost structure of a bed. Thus, locating the mattress will typically provide for the location of the top surface of the bed (which is the surface typically of most interest) and because the mattress is at the top, also helps to eliminate various edges or shapes as being part of the mattress because they are too low.

However, when the system is looking for the mattress, it must be recognized that the position of the system in the room relative to the bed, and the current positioning of the bed, will typically mean that the upper surface will not usually be a rectangle within the image. Instead, what will typically be present is a series of interconnected, and sometimes incomplete, polygons. However, from these polygons, a number of examinations may be performed to try and locate the bed upper surface by connecting edges and angles into possible polygons of correct shape and size. If these match up, secondary parameters such as height from the floor and completeness of the polygon can be used to further refine and make sure that the polygon both is a bed surface and is correctly positioned in the image to provide valuable information.

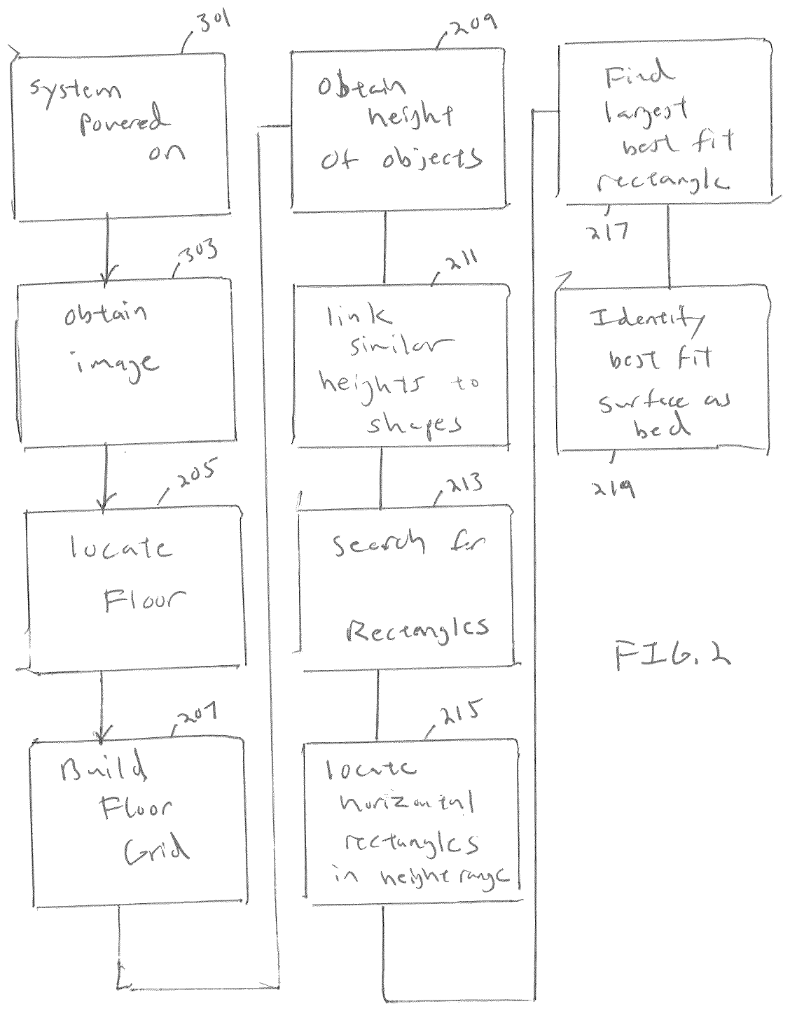

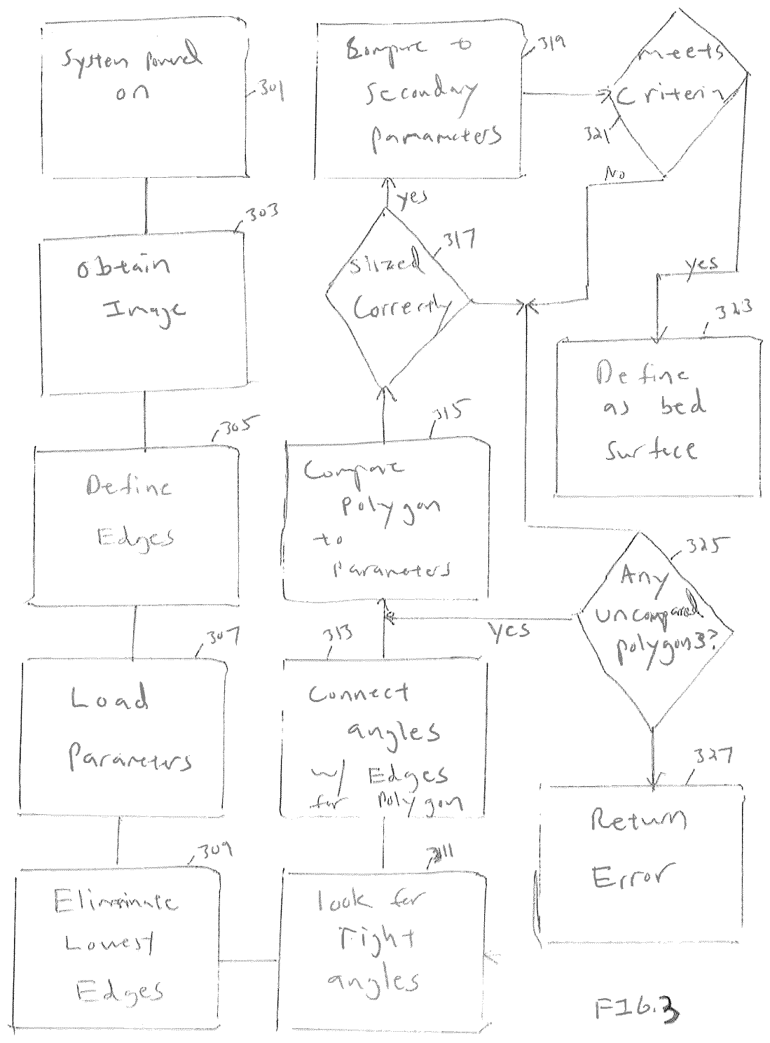

FIG. 2 provides a hypothetical block diagram illustrating the process that can be gone through to look for the bed surface in an initial setup image. The embodiment of FIG. 2 utilizes a relatively simple bed detection method which utilizes fewer steps than that of FIG. 3. In FIG. 2 the method will typically begin when the system is powered on having be brought into the room in step (301). The first thing the system will do is obtain a depth image from the camera (303). The system will then proceed to locate and define the floor of the room (205). The walls will often also be defined at the same time. The floor will typically be the furthest surface from the camera which is horizontal. Any elongated vertical surface from the floor and extending to the top of the image may be determined to be a wall.

Once the floor is defined (205), the floor will typically be extended as a hypothetical plane within the entire image. That plane will then be broken into a floor grid (207) which defines the floor typically as a tessellated pattern of squares or other similar regular polygonal tiles arranged in a regular pattern. The floor grid tiles may be of any size but typically increasing the number will increase the resolution of the detection. At each tile in the floor grid, the height of any objects may be determined (209). In most cases, the height of any object is effectively the height of the tile as the object will commonly take up the entirety of the tile. The height of the objects is determined based on reference to the plane of the floor.

After heights have been assigned to each tile, neighboring tiles of similar or the same height will be connected to form shapes (211). As should be apparent, if the floor grid comprises squares or other linear-sided polygons, the shapes formed will generally also be linearly sided. The number of sides will also generally arrange from the fewest corresponding to the number of sides of the tile. In the event that squares or rectangles are used, these simplest shapes will typically be rectangles or squares themselves.

Once the shapes have been defined (211), the system will look for rectangles and arrangements which are close to rectangles (213) above the floor. In many respects, this is searching for relatively long groupings which form a line along one edge. As should be apparent, these rectangles need not be perfect, but the system will typically have a certain level of tolerance for error in producing what is described as a rectangle versus what is not. In an embodiment, a collection of tiles which is close to a rectangle, but is not a rectangle, may be made into a rectangle by deleting extra tiles to produce the largest rectangle within the shape detected. In a still further embodiment, if a shape which is in the form of a rectangular frame or partially rectangular frame (e.g. a rectangle with an enclosed section or partially enclosed section which is not of consistent height with the perimeter) the tiles within the frame which are not at the same general height as the height of the frame may be modified to be at the height of the frame.

Once rectangles are located (213), the rectangles which are horizontal are determined based on neighboring tiles having generally similar height. As should be apparent, these should generally correspond to elevated horizontal surfaces in the room and the upper surface of the bed should comprise one of these. With the horizontal rectangles having been detected, each such rectangle is then connected with its detected height and rectangles which are within the height range of the expected bed surface are identified (215). As discussed previously, hospital beds will typically be of relatively specific height ranges. Even if a specific brand or design of a bed present in a room is unknown, these ranges are still relatively narrow. In the event that it is known that a specific brand or design of bed is used, the band may actually be quite narrow.

The horizontal rectangles within the height band are those which could represent the bed's upper surface. Once they are identified, the system will typically identify the rectangle which is the largest (e.g. has the most number of tiles) (217) in that height range. This is identified as the surface of the bed (219). The system may stop there or this identified rectangle may be expanded by looking for nearby tiles and/or rectangles that are also within the same or similar height band but which were not included in the original shape. These may then be added to the rectangle in a fashion to make a larger rectangle which is believed to more closely represent the bed surface.

Again, this expansion may use known features of the hospital bed. For example, if the generally surface area of the bed is known, the identified first rectangle may be treated as a portion of a larger rectangular surface having that surface area and the system may look to find a best fit of nearby tiles that provides the most tiles in the height range that are within such an expected shape having that expected surface area. The system may also fill in gaps or eliminate unexpected heights within the rectangle. In effect, a “best fit” plane may be applied to the rectangle. This may be necessary, for example, if the bed already has a patient in it. In this case, the bed surface rectangle may actually be in the form of a donut with a raised center (which is the patient). In this case, using a plane at the height of the outside of the rectangle helps to put the upper bed surface at a more accurate height and even to initially identify a cloud which could be the human patient.

It should be recognized that the embodiment of FIG. 2 does not actually use edge detection as the system does not locate edges in the typical fashion. Instead, the system essentially creates artificial edges as part of the tiles and then creates shapes or surfaces using those tiles. The shapes have edges, but they correspond only to changes in height, not to edges that are actually detected by the depth camera. The embodiment of FIG. 2 can be valuable as it is a relatively straight forward and simple system to locate the bed surface. However, in some situations, it may be overly simple and a more complex, or at least different, identification method may be needed. FIG. 3 provides an alternative embodiment of a method for detection which relies on more traditional edge detection.

FIG. 3 will typically begin in the same way as the method of FIG. 2 with the system being powered on having been brought into the room in step (301). The first thing the system will do is obtain a depth image from the camera (303) and define edges within the image (305). It is generally intended that the camera image will not be blocked by an operator and any obvious obstructions would be removed from its field of view at the start if the system is correctly positioned facing the bed. However, the system will typically work with whatever image it can take as, in an embodiment, the system will identify that it is not facing a bed (19) or its view is blocked. For example, that the camera has been placed with the imager (13) facing the wrong direction and, therefore, a bed (19) is nowhere in the field of view.

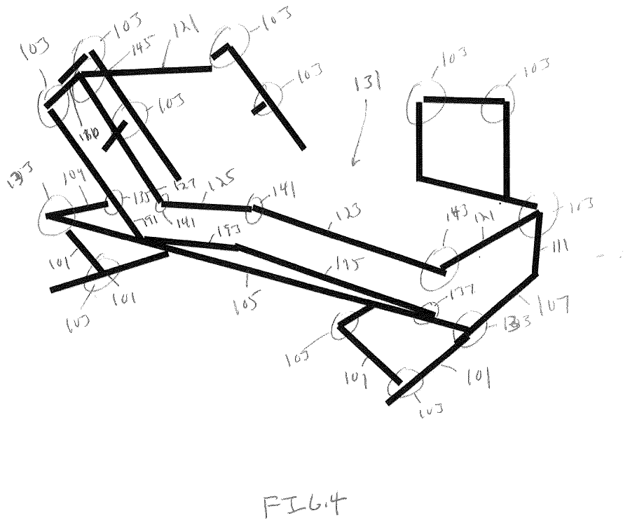

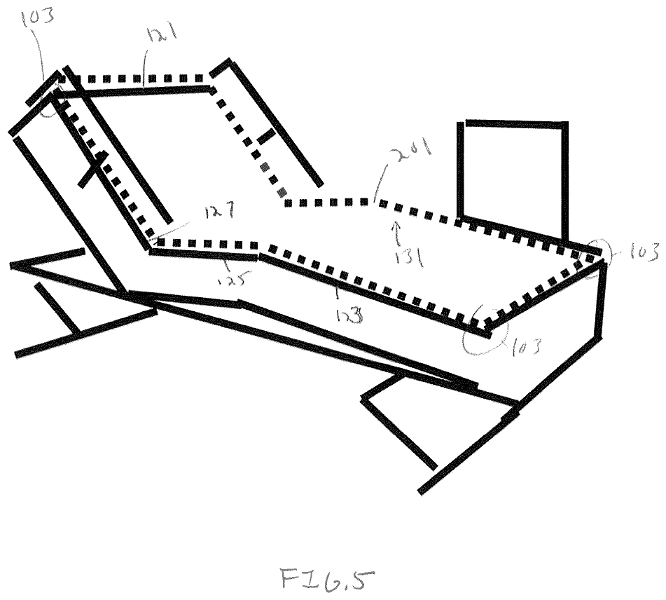

FIG. 4 provides a purely hypothetical collection of detected edges from a depth image which are shown as dark solid lines. This drawing is not intended to provide an accurate representation of what a depth camera can or will see or even how a field of edges would actually appear. FIG. 4 is instead intended to simply illustrate the concept of how the bed surface (201) of FIG. 5 can be defined based on lines representative of edges. In FIG. 4, the various lines are each a detected edge located by the depth camera (11).

Once the edges have been obtained as in FIG. 4, the system (10) will begin to look for the bed surface (201). As contemplated in FIG. 3, the first thing that the system will typically do is load the parameters of the bed it is looking for (307). These parameters will define various features of the edges of the various bed components, and the upper mattress surface that is of primary interest, that are being looked for in the image. The parameters selected are basically the ranges of elements that define a bed (19) in this facility and are typically narrowed as much as possible for the specific bed (19) that the system (10) may be looking for in this case. As a simple example, if the facility using the system only uses one kind of bed (19) in this facility, the specific parameters of that bed (109) (e.g. its specific dimensions) may be provided to the system (10), this can then allow for parameters which are very narrow as the beds (19) are of very specific design. Should multiple types of beds (19) be used in the facility, the parameters may provide for larger ranges that cover the multiple types. Finally, if the number of different types of beds (19) is large, or the types of beds (19) used are unknown, certain default parameters may be used which can include a majority of possible beds (19). In addition to choosing parameters of beds (19) for generic rooms, if it is known that the patient is using a specific bed (19) (e.g. a bariatric bed which is generally larger) that can be entered and the parameters for those types of beds (19) may be used. Alternatively, these special types of beds (19) may be included within the general parameters, but will often provide for separate windows of ranges instead of being included within a general common range.

Once the parameters of beds (19) have been loaded (307), the system may begin looking for the bed (19) in the edges such as is shown in FIG. 4. Edges are particularly valuable in conjunction with the dimensional parameters because those parameters will correspond to the length of various edges in the image and specifically the ratio of various edges to each other. Thus, edges may be searched for that correspond to the various desired lengths either in absolutes or in ratios. Because the bed can be at an angle in the image, absolute dimensions of an edge may be determined using calculations based on vanishing points and similar understood imaging characteristics when a 3-dimensional object is imaged into a 2-dimensional image or, alternatively, ratios may be used to avoid the need to perform literal measurements.

In addition to looking for edges of specific dimensions, the search for the bed (19) will also typically allow for various other determinations to take place to either indicate that a edge is more or less likely to be a mattress edge. Turning to FIG. 4, a human viewer is likely to be able to see a potential bed surface (201). However, a machine will typically only see lines as it lacks the automatic depth generation that is done by human visual processing. A few of the additional processing steps that may be taken by the system in locating the bed surface (201) are to first eliminate the lowest possible lines (e.g. lines (101)) (309) as the upper surface (201) of the mattress should not correspond to the lowest detected edges. Even if the lowest lines are the actual edge of the mattress, an image with such positioning will typically mean that the system (10) is aimed too high and should generate a positioning error. Specifically, the system (10) typically needs to be able to image the floor by the bed (19), as this will be a location where a patient could have fallen and will need to be detected. Assuming that the system (10) is correctly positioned, the lowest lines (101) will typically correspond to structure under the bed (19) such as the mechanical support mechanisms and wheel axles.

As a next step, the system may look for angles (103) that could be representative of right angles (311) depending on the viewing angle of the system to the bed (19). It should be recognized that the located angles are not necessarily right angles in the image of FIG. 4, and typically won't be, because the system (10) will typically not be aligned with an edge of the bed (19) but the parallelepiped shape will be in perspective. However, normal processing algorithms can determine which angles could be right angles (103). Specifically, the system will often be able to determine that if a first angle (103) is a right angle (based on a specific point-of-view), which other angles (103) would also be right angles from that same point-of-view. This effectively allows for the system to look for the possible corners of the rectangle of the bed surface (201). Comparison of angles can also be used to determine a potential angle that the system (10) is likely positioned relative to the bed by using corresponding angles.

Once a number of possible lines and angles have been identified, the edges and angles will often be grouped into polygons (313). In this step, the system will look to a particular combination of lines which interconnect with other angles (usually three or four) recognizing that if any one of the angles would be a right angle, the others also would be. The polygon will also typically have generally linear edges connecting the angles as these aspects are generally necessary in the appearance of a bed surface (which is typically generally rectangular) If the angles work out, the system (10) will then typically make sure that the two opposing “sides” of the polygon would likely have the same length. It should be recognized that, as in FIG. 4, there may be gaps (131) where no edge was detected or even a missing angle. In this case, the system will often fill in a false edge or angle which could correspond to the opposing edge (in this case (line (125)) which would need to be present if this was the bed surface in step (313).

Once the polygons have been defined which would appear to have four right angles (assuming one of them is a right angle) and interconnecting edges between those angles, the system will then generally determine if lines forming this hypothetical surface are around the correct length, width, depth, or ratio of the bed surface in step (315). In this case, for example, line (105) would be detectable as being about the right length to be the length of the bed surface and the polygon could comprise lines (105), (109), (191), (193) and (195). However, this would also likely not be detected as being an edge of the bed surface (201) as, while line (107) could be the width, edge (109) would seem to be too short and indicate that something is not correctly visible. Further, edge (111) would seem to go the wrong way to be a depth and while angles (133) would appear to be possible right angles, the angles (135) and (137) likely are not. Further, the lines (191), (193), (195) and (197) in combination do not seem in any way to mesh up as having the same length as line (105) and being parallel to it. Thus, this polygon will generally not be determined to be part of the upper bed surface (201) and would be eliminated at step (317). The system will then return either looking at the next polygon or locating further polygons in step (325).

While the polygon above does not seem to be correct, the polygon (201) of FIG. 5 is a different story. Lines (123), (125), and (127) are each too short to be the length of a mattress, but together they would appear to be the right length and they can be connected between angles that could comprise four generally right angles. It should be noted that lines (123), (125), and (127) may be grouped as segments of the same line because the angles (141) cannot be right angles if the angle (143) is. However, if the angle (143) is a right angle, the angle (145) could be. As the sides of the bed surface (201) have to be between two right angles, the combination of (123), (125), and (127) meets the criteria while no one individually does. Further, these lines are near the top of the detected object and with lines (121) seem to define the possible rectangular shape (although bent as would be the case if the bed was adjusted to a sitting position). Further, lines (111) and (110) together would also appear to be the right length to be the depth of the mattress. It should be recognized that the polygon (201) could also be made using the back bed rail edge inadvertently. This is typically acceptable as such a surface is still very close. In many cases, distinction between these possible edges is likely a factor of how narrow the parameter ranges can be in this particular determination.

Based on the polygon (201) made from these edges and angles there appears to be little contradiction to them potentially being the edges of the mattress, and there are not any other polygons that likely would be the bed surface. The system in FIG. 4 then fills in the form to define a possible bed surface (201) which will now be compared, in an embodiment, to certain secondary parameters in step (319). As should be apparent, the defined bed surface (201) is not a rectangle, but is actually the shape of a rectangle that is bent and viewed at an angle as would be the case if the head and foot of the bed (19) have been raised as would commonly be the case for a bed (19) in a sitting position. This type of available positioning can also be used as one of the secondary parameters of the bed (19) which are the positions it is possible for the bed (19) to be in. Specifically, most hospital beds (19) have defined patient positions both for medical reasons (e.g. flat but with head raised or lowered) or for patient comfort such as the sitting position. Thus, if a bed (19) of dimensional parameters is found but which is not rectangular, these secondary parameters could be refined to allow for specific allowed positions of the bed (19) to help verify that the detected polygon is actually the surface (201) of the bed. Specifically the individual segments (123), (125), and (127) could be evaluated as possible lengths for the segments of the mattress when bent around the known possible points of adjustment if the bed (19) was in the sitting position. In this case, the segments (123), (125), and (127) do match up in step (321) and the polygon is defined as the bed surface (201).

Once a bed surface (201) has been detected any number of secondary parameters may be used as part of the verification, including none. For example, it may be determined if the bed surface (201) is sufficiently visible in the image to be useable and there are not too many gaps (131) filled in a secondary parameter. In many cases, if the bed surface (201) is not sufficiently visible, the gaps (131) would mean the system may not be able to locate a bed surface (201) and this would itself trigger an error condition (337) because there is no polygon which could be the complete bed surface (201). This could occur, for example, if the system (10) was not able to fill in the gap (131) as there would then not be any shape corresponding to the bed surface (201) which is detected. However, if there are too many gaps (131) that need to be filled to detect the bed surface (201), the system may determine that the image is likely sufficiently blocked to trigger an error and request repositioning. Further, if the bed surface was not completely in the frame of FIG. 3, the system would also generally provide an error situation (327) as the bed surface (201) cannot be detected, but interaction with the edge of the image could also be a secondary parameter. Finally, even if the bed surface (201) is believed to be detected, other requirements, such that it be with a distance parameter of the floor can also be used to make sure that the system is correctly aimed to detect, for example, falls from the bed surface (201).

Once a possible bed surface (201) is defined, the system may then continue and may seek to define other objects in its field of vision. As a simple example, the system (10) may seek to look for humanoid shapes in its field of view. It may look for such on the surface (201) of the bed or elsewhere in the room. Alternatively, the system (10) may simply determine that anything which is not the bed surface (201) can be treated as background and ignored, at least until it changes position.

If the system is unable to find a bed and enters an error (327), this will typically be due to two possible issues. In the first, the system (10) has been positioned in a way that the bed (19) is not within its field of view or is only partially visible such as it being obscured or only partially in the field of view. The error is expected to be relatively common as this is the case when the system (10) is incorrectly positioned, generally through operator error. For this reason, should an error be returned, the system (10) will typically simply instruct a user to “aim it at the bed” or something similar. Should movement of the image be detected, the system (10) will typically stop the error and then reset to step (301) to look again to identify a bed surface (201). An advantage of the system is that failure to detect a bed surface (201) is a target result of the system (10), so the system (10) failing to detect the bed surface (201) is not a problem with the system (10), but likely operator error which the system (10) is intended to detect.

If no bed (19) is detected and there is no movement, if too many consecutive errors have been detected, or if the user indicates that bed (19) is in the field of view using other inputs, the depth image may be presented to the user and they may be instructed to identify the bed surface (201) in the image essentially avoiding the steps of FIG. 3 until step (319). This type of error is concerning as it may not be due to a user error, but may be due to a system malfunction or inaccuracy. Once as user has identified the bed surface (201) (e.g. such as by indicating or drawing the relevant edges or by selecting elements of the image that correspond to the surface) the system (10) will then utilize the bed area in future calculations and may use additional parameters to verify that it is correctly positioned relative to that bed surface (201). Alternatively, it may check this polygon to see why it was not previously automatically selected.

In an embodiment, if the user defined polygon does not meet enough secondary parameters in step (319) (for example, if the surface is clearly incomplete and extends over the edge of the image), the system (10) may indicate that the aiming of the system (10) is still inaccurate (user error) and should be corrected because while the bed surface (201) has been identified, the bed surface (201) does not actually meet the secondary parameters (319). This indicates there is a problem and effectively there is still operator error. The system may even provide feedback to the user on expected ways to improve the positioning. For example, if the bed surface (201) is believed to be too low in the image, the system (10) may encourage the user to aim the camera (11) downward. The system (10) may also update the parameters, or utilize machine learning or similar methods, to update the parameters and/or its methodology for detecting the bed surface (201) after a user manually indicates a bed surface (201).

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “spherical” are purely geometric constructs and no real-world component or relationship is truly “spherical” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A method for a depth imaging system to detect a bed, the method comprising:
providing a depth camera image;
locating a floor in said image;
tessellating said image into a series of tiles;
determining a height from said floor of each of said tiles;
locating collections of said tiles at similar height and connecting them into a shape;
determining which of said shapes are generally rectangular;
determining which of said rectangular shapes are at a height within a defined height range;
assigning a largest of said rectangular shapes within said defined height range to be a bed surface.

2. The method of claim 1, further comprising:
in said determining which shapes are generally rectangular, filling in gaps within a frame of the shape so as to make tiles within the shape generally the same height as the frame.

3. The method of claim 1 wherein said defined height range is selected based on an expected height of a hospital bed within a facility in which the depth imaging system is being used.

4. The method of claim 1, wherein said tiles are generally rectangular.

5. The method of claim 4 wherein said tiles are generally square.

6. A method for a depth imaging system to detect a bed, the method comprising:
providing a depth camera image;
locating edges in said image;
loading parameters which are indicative of a bed;
eliminating lowest edges in said image;
locating right angles in said image and connect edges using said right angles to form polygons;
comparing said polygons to said parameters to determine which polygon is a best fit within said parameters;
assigning said best fit of said polygons to be a bed surface.

7. The method of claim 6, further comprising:
during said comparing, also comparing said polygons to a set of secondary parameters to determine which polygon is a best fit within both said parameters and said secondary parameters.
